(19) United States
(12) Patent Application Publication
(10) Pub. No.: US 2012/0062011 A1
(43) Pub. Date: Mar. 15, 2012

(54) BRUSHLESS DC MOTOR STARTS FOR A BARRIER FREE MEDICAL TABLE

(75) Inventors: Chris Jones, Fort Wayne, IN (US); Rodney Hyre, Versailles, OH (US)

(73) Assignee: MIDMARK CORPORATION, Versailles, OH (US)

(21) Appl. No.: 12/878,321

(22) Filed: Sep. 9, 2010

(51) Int. Cl. A61G 15/10; A61G 15/02; H02P 6/22

(52) U.S. Cl. 297/362.11; 318/400.11

(57) ABSTRACT

A boot-strap capacitor pre-charge algorithm prevents unwanted motions in an examination table using a brushless direct current motor. The motor is supplied with power by a motor drive circuit which includes a high-side transistor coupled to a high-side gate driver, a low-side transistor coupled to a low-side gate driver, and a boot-strap capacitor coupled with the high-side gate driver. A control panel is provided that communicates with a motor controller. When the motor controller receives an indication that the motor is to be started, the motor controller activates a low-side gate driver to switch on the low-side transistor, thereby causing the boot-strap capacitor to charge. The motor controller then deactivates the low-side gate driver to switch off the low-side transistor and activates the high-side gate driver to switch on the high-side transistor, causing a voltage to be supplied to a stator of the first motor and/or second motor.

### FIELD OF THE INVENTION

This invention relates generally to examination tables for medical procedures, and more specifically, a motor control for the examination tables.

### BACKGROUND OF THE INVENTION

Examination tables are incorporated in medical offices for supporting or positioning patients undergoing medical procedures or examinations. Conventional examination tables include a base and a support surface mounted on the base. In order to provide a more comforting support arrangement for the patient, the support surface may include a seat portion and a backrest portion that pivots with respect to the seat portion. Thus, the support surface can be moved from a chair position where the support surface resembles a chair to an examination position where the support surface resembles a substantially flat and elevated examination table, depending upon the current needs of the patient and user.

Conventional examination tables also typically include an actuation system for moving the support surface and the backrest portion. The support surface is moved vertically by a scissor lift or another lifting mechanism incorporated into the base of the examination table. The backrest portion of the support surface may be pivoted with respect to the seat portion with a lift cylinder or another similar drive mechanism. The lifting and drive mechanisms of the actuation system may be independently driven by electric motors, hydraulic motors, or other types of motors. Conventional examination tables also include a control system operatively connected to hand-operated and/or foot-operated control panels provided on the examination table. The control system receives input from the control panels and then activates the motors of the actuation system to move the support surface or the backrest portion.

A Brushless DC (BLDC) motor is a rotating electric machine, typically having a 3-phase stator and a rotor employing permanent magnets. BLDC motors are well suited for use in medical examination tables because they have several advantages over other types of motors, including higher torque, higher efficiency, longer operating life, lower maintenance, and quieter operation. BLDC motors may be configured with rotors located inside, outside or stacked next to the stator.

Because the stator field necessary to move the rotor in a particular direction may be dependent on the orientation of the rotor, to accurately control rotor motion, a motor controller should be able to determine the positions of the rotor magnets relative to the stator. This allows the controller to activate the stator windings in a sequence that continually shifts position of the stator magnetic field to keep the field ahead of the rotor. Rotor position may be detected with sensors, or by sensing a back EMF on the stator windings. Because the back-EMF is only produced when the rotor is moving, starting a BLDC motor without position sensors from a dead stop can be challenging. One method to initiate rotation is to assume an arbitrary rotor start up phase and later correct the phase if the startup phase turns out to be wrong. A disadvantage to this method is that incorrect rotor phase assumptions may cause the motor to either not move initially or move backwards until the phase error is corrected. These start up problems can also occur in BLDC motors employing position sensors if the sensors are dirty or misaligned, or may occur due to limitations on position sensor resolution.

Another start up challenge with BLDC motors involves stator driver voltages. For some drive circuits, the controller circuitry may operate at voltages in the range of approximately 3-12 volts, while a BLDC motor generally requires much higher voltages, sometimes in the range of approximately 50-100 volts, depending on the application. Circuits supplying power to a single winding of the stator typically include two switching devices, with one device connecting the stator winding to the motor's positive power supply voltage, and the other connecting it to ground. In this way, the drive circuit may cause current to flow into or out of the stator winding as needed by activating the respective switching device. Many driver circuits use a MOSFET, IGFET, or Bi-Polar transistor as the switching device, with the controller circuitry applying a voltage to a gate driver, which in turn causes the device to turn it on and off. Because the controller circuitry is running at a much lower voltage than the motor, it is incapable of supplying a high enough voltage to keep the high side switching device on when it is applying power to the stator winding. This is typically solved by placing a gate driver between the controller circuitry and connecting a bootstrap capacitor between the input of the stator winding and gate driver. The bootstrap capacitor causes the gate driver supply voltage to rise along with the stator winding input voltage so that it can keep the switching device active. However, the driver device generally cannot activate at initial motor start up until the bootstrap capacitor has built up a charge sufficient to power the gate driver. This can cause an under-voltage lockout condition that prevents motor from turning.

Another challenge with BLDC motors relates to precisely stopping the motor through use of active braking. This problem is exacerbated by the widely varying loads seen on medical examination tables, which may cause the moving parts of the table to drift past the desired stopping point. One way to achieve active braking is to cause the BLDC motor to apply torque in opposition to the forward motion of the examination table. However, because of the aforementioned difficulties in knowing how much torque to apply and for how long, simply reversing the BLDC motor may result in the examination moving backwards away from the desired stopping point.

Because of the challenges associated with consistent starting and stopping of BLDC motors, and the sensitive nature of medical examination tables, there is a need for systems and methods to ensure that BLDC motors both start and stop consistently as well as rotate in the correct direction when used to adjust the position of medical examination tables so as to avoid alarming patients and doctors using the table.

### SUMMARY OF THE INVENTION

Embodiments of the invention provide a motor control system employing a motor drive circuit which includes a high-side transistor coupled to a high-side gate driver, a low-side transistor coupled to a low-side gate driver, and a boot-strap capacitor coupled with the high-side gate driver. The motor controller is configured to determine a position of a rotor of a motor, and based on the rotor position; activate the low-side gate driver, thereby switching on the low-side transistor in such a way as to cause the boot-strap capacitor to charge. Once the boot-strap capacitor is charged, the motor control system deactivates the low-side gate driver, switching off the low-side transistor. The motor control system then activates the high-side gate driver, switching on the high-side transistor, supplying a voltage a stator of the motor.

Embodiments of the invention also provide a method of starting a brushless direct current motor by determining the position of a rotor of the motor, and based on the rotor position, activating a low-side gate driver of a motor drive circuit to switch on a low-side transistor of the motor drive circuit. This causes a boot-strap capacitor of the motor drive circuit to charge. When the boot-strap capacitor is charged, the low-side gate driver is deactivated to switch off the low-side transistor. A stator of the motor is then supplied with a voltage by activating a high-side gate driver of the motor driver circuit to switch on a high-side transistor of the motor drive circuit.

Embodiments of the invention additionally provide an examination table including a base and a support surface mounted on the base, where the support surface includes a seat portion and a backrest portion. The support surface is configured such that it may be positioned relative to the base by a first brushless direct current motor, and the backrest portion is configured so that it may be positioned with respect to the seat portion by a second brushless direct current motor. The motors are supplied with power by a motor drive circuit, which includes a high-side transistor coupled to a high-side gate driver, a low-side transistor coupled to a low-side gate driver, and a boot-strap capacitor coupled with the high-side gate driver. A control panel is provided for use with the examination table with at least one button that communicates with a motor controller. The motor controller is configured to determine a position of a rotor of the first motor and/or a position of a rotor of the second motor. Based on the position of the rotor, the motor controller activates the low-side gate driver to switch on the low-side transistor, wherein switching on the low-side transistor causes the boot-strap capacitor to charge. The motor controller then deactivates the low-side gate driver to switch off the low-side transistor and activates the high-side gate driver to switch on the high-side transistor, causing a voltage to be supplied to a stator of the first motor and/or second motor.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of a medical examination table.

FIG. 2 is a side view of the medical examination table of FIG. 1 showing the seatback in an upright position.

FIG. 3 is a front view of a control panel for use with the medical examination table of FIG. 1.

FIG. 4 is a side view of the medical examination table of FIG. 1 showing the seatback in a reclined position.

FIG. 5 is a schematic block diagram of a BLDC motor with control and motor driver systems for use with the medical examination table of FIG. 1.

FIG. 6 is a schematic block diagram of an exemplary BLDC motor control algorithm for use with the motor control and drive of FIG. 5.

FIG. 7 is a schematic diagram of an exemplary motor drive circuit for use with the motor control algorithm of FIG. 6.

FIG. 8 is a flow chart for an exemplary BLDC control system motor control algorithm to pre-charge a motor drive circuit for use with the motor control and driver of FIG. 5.

FIG. 9 is a table containing relationships between position sensor signals and motor driver circuit states for a BLDC motor, such as the motor of FIG. 5, rotating in a counter-clockwise direction.

FIGS. 10A-F are schematic diagrams of a 3-phase stator showing winding currents for each of the motor circuit states in FIG. 9.

FIG. 11 is a flow chart for an exemplary BLDC control system braking algorithm for use with the motor of FIG. 5.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

Embodiments of motor start/stop control include software algorithms configured to control BLDC motors, which may be deployed in a medical examination table environment. Such algorithms may include a run-state algorithm, a pre-charge algorithm, a phase-retardation algorithm, and a braking algorithm. Each of these algorithms may be implemented in a BLDC motor controller in some embodiments, or in other embodiments may be implemented in other control systems utilized by the medical examination table. Any of the control circuits used for motor control may be implemented with appropriate logic circuits, microprocessors, FPGAs, ASICs, etc.

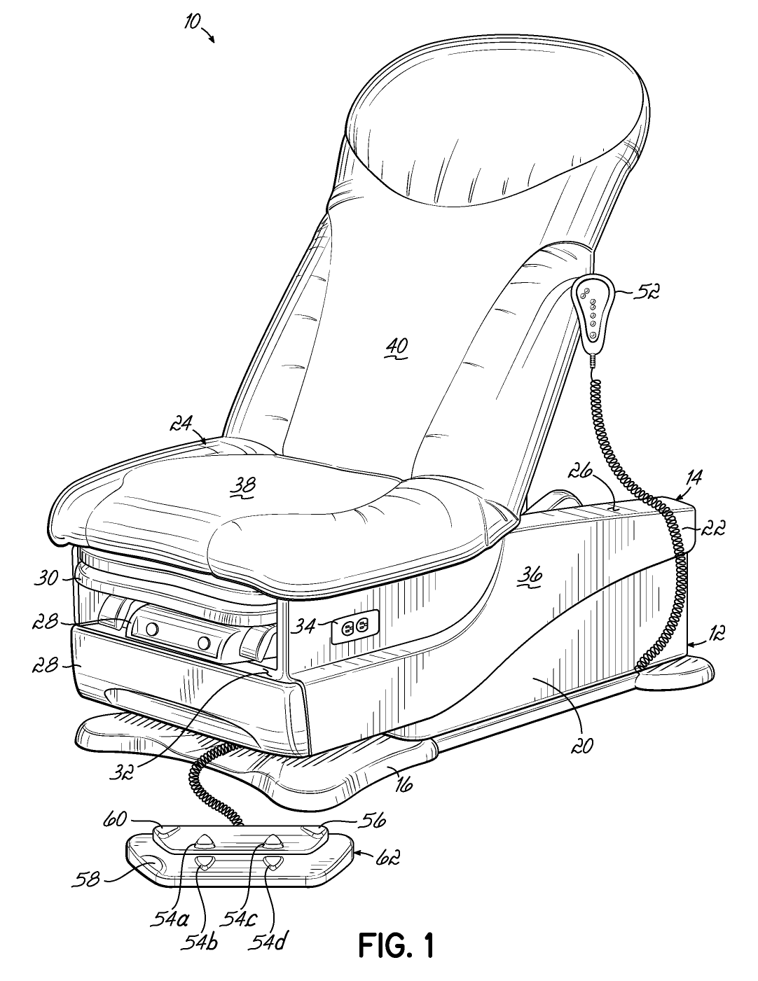

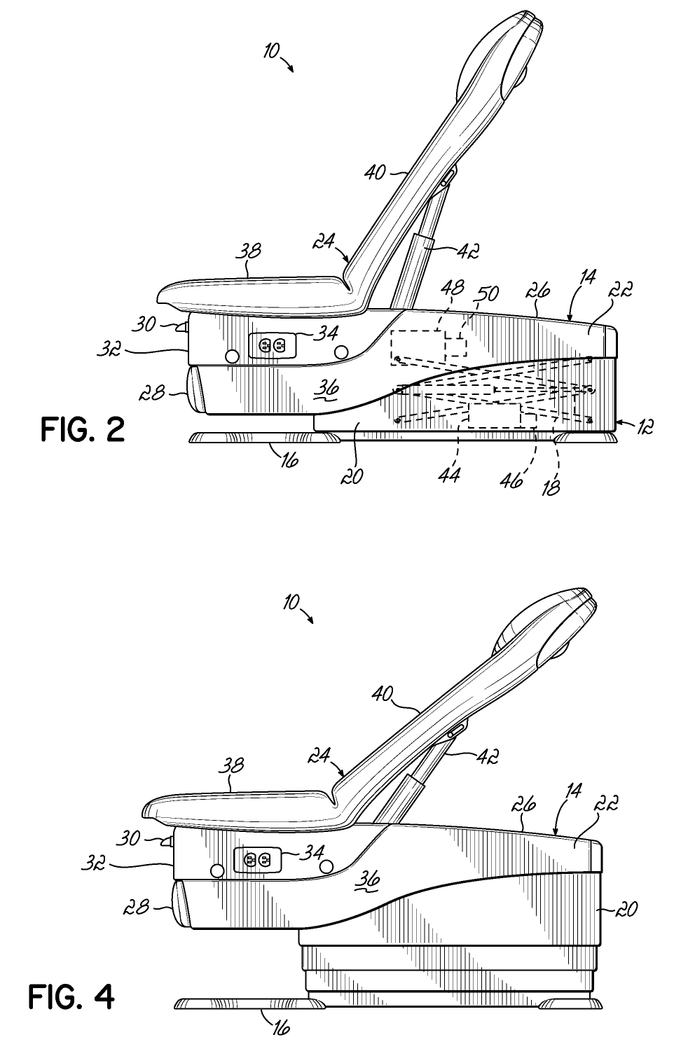

One embodiment of an examination table 10 is illustrated in FIGS. 1-4. The examination table 10 includes a base portion 12 and a table portion 14 disposed above the base portion 12. The base portion 12 includes a base member 16 for supporting the examination table 10 on a floor surface. The base portion 12 also includes a scissor lift 18 (shown in phantom in FIG. 2) engaged with the base member 16 and the table portion 14. The scissor lift 18 is operable to move the table portion 14 generally upwardly and downwardly with respect to the base member 16. The scissor lift 18 and all other internal components of the base portion 12 are stored within a telescoping shell cover 20. The telescoping shell cover 20 telescopes outwardly from the base member 16 to the table portion 14.

The table portion 14 further includes a table frame 22 and a support surface 24. The table frame 22 defines a generally planar upper surface 26 for supporting the support surface 24. The table frame 22 may also include a plurality of storage drawers 28 and retractable instrument pans 30 at a front surface 32 of the table frame 22. The storage drawers 28 and retractable instrument pans 30 provide convenient storage areas for a user such as a medical professional during patient examinations and procedures on the examination table 10. The table frame 22 may further include at least one electrical outlet 34 positioned along a side surface 36 of the table frame 22. The electrical outlet 34 is powered by the power supply to the examination table 10 and permits convenient electrical power for accessory devices used with the examination table 10 or during a medical procedure.

The support surface 24 is divided into a seat portion 38 and a backrest portion 40. The support surface 24 is generally padded or cushioned to more comfortably accommodate a patient. The seat portion 38 is rigidly coupled to the upper surface 26 of the table frame 22 adjacent to the front surface 32. The backrest portion 40 extends behind the seat portion 38 and may be pivoted with respect to the seat portion 38. A lift cylinder 42 or similar device is engaged with the backrest portion 40 and the table frame 22 to pivot the backrest portion 40. The lift cylinder 42 and scissor lift 18 combine to form an actuation system for moving the examination table 10 through various positions such as the initial position shown in FIG. 4. It will be appreciated that various other lifting mechanisms could be substituted for the scissor lift 18 and the lift cylinder 42 in other embodiments.

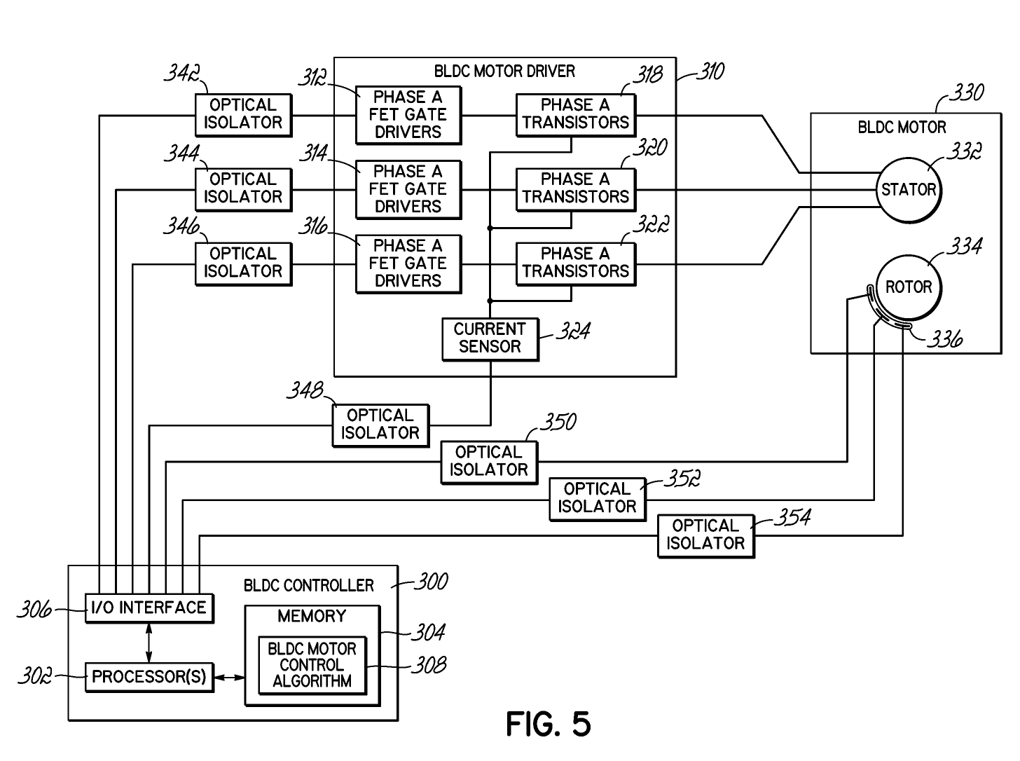

The actuation system also includes a first motor 44 operatively coupled to the scissor lift 18 and a control system (such as controller 300 in FIG. 5) of the examination table 10. The first motor 44 drives the scissor lift 18 to move the table portion 14 and support surface 24 between a proximal position with respect to the base member 16 and a distal position with respect to the base member 16. The first motor 44 is a brushless direct current (BLDC) electric motor in the illustrated embodiment, but a hydraulic motor or another type of motor may be used in other embodiments. The control system includes a first Hall-effect sensor 46 coupled to or incorporated into the first motor 44. As the first motor 44 rotates, a magnet of the first Hall-effect sensor 46 rotates with the first motor 44 and thereby modifies a localized magnetic field in the vicinity of the first motor 44. The first Hall-effect sensor 46 includes a current-carrying electrical circuit that is affected by these changes in the localized magnetic field, and thus, the first Hall-effect sensor 46 can detect full rotations of the first motor 44. In some embodiments, a plurality of first Hall-effect sensors 46 may be used to determine partial rotations of the first motor 44. In still other embodiments, other types of sensors may be used to determine motor rotations.

The actuation system of the examination table 10 further includes a second motor 48 operatively coupled to the lift cylinder 42 and the control system. The second motor 48 drives the lift cylinder 42 to move the backrest portion 40 of the support surface 24 between a first position adjacent to the table frame 22 and a second position angled upwardly from the table frame 22 and seat portion 38. The second motor 48 is also a brushless direct current (DC) electric motor in the illustrated embodiment. The control system includes a second Hall-effect sensor 50 coupled to or incorporated into the second motor 48. The second Hall-effect sensor 50 operates in an identical manner as the first Hall-effect sensor 46 to detect rotations of the second motor 48. The first and second Hall-effect sensors 46, 50 provide motor rotation position information to the control system, and the control system actuates the first and second motors 44, 48 in accordance with these sensed rotations.

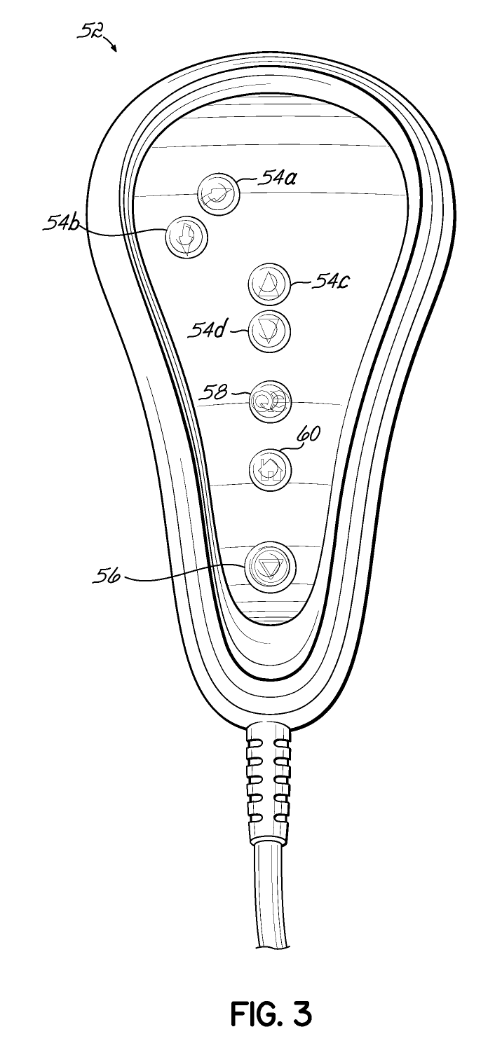

The control system of the examination table 10 further includes a control panel 52 as shown in FIGS. 1 and 3. The control panel 52 is configured to be held in a user's hand, and may be stored on the backrest portion 40 when not in use. The control panel 52 includes a plurality of buttons for controlling the operation of the actuation system. The control panel 52 includes a set of manual control buttons 54a, 54b, 54c, 54d for individually driving the first and second motors 44, 48 in a certain direction. Thus, the first manual control button 54a causes the second motor 48 to drive the backrest portion 40 upwardly toward the second position, while the second manual control button 54b causes the second motor 48 to drive the backrest portion 40 downwardly toward the first position. Similarly, the third manual control button 54c causes the first motor 44 to drive the support surface 24 upwardly toward the distal position, and the fourth manual control button 54d causes the first motor 44 to drive the support surface 24 downwardly toward the proximal position. Similar operations may be performed using the foot pedal 62.

BLDC Controller 300, illustrated in FIG. 5, may communicate directly with the control panel 52 or foot pedal 62 or may receive control signals from another controller within the examination table 10. Controller 300 may be implemented using one or more processors 302 selected from microprocessors, micro-controllers, digital signal processors, microcomputers, central processing units, field programmable gate arrays, programmable logic devices, state machines, logic circuits, analog circuits, digital circuits, and/or any other devices that manipulate signals (analog and/or digital) based on operational instructions that are stored in a memory 304. Memory 304 may be a single memory device or a plurality of memory devices including but not limited to read-only memory (ROM), random access memory (RAM), volatile memory, non-volatile memory, static random access memory (SRAM), dynamic random access memory (DRAM), flash memory, cache memory, and/or any other device capable of storing digital information. Input/Output (I/O) interface 306 may employ a suitable communication protocol for communicating with other controllers and computing devices, and may include ports capable of receiving and transmitting both analog and digital signals.

Processor 302 may operate under the control of an operating system, and may execute or otherwise rely upon computer program code embodied in various computer software applications, components, programs, objects, modules, data structures, etc. to read data from and write instructions to the BLDC Motor Driver 310, and BLDC Motor 330 through I/O interface 306, whether implemented as part of the operating system or as a specific application. The computer program code typically comprises one or more instructions that are resident at various times in memory 304, and that, when read and executed by processor 302, causes the BLDC Motor Control Algorithm (BMCA) 308 to perform the steps necessary to execute steps or elements embodying the various aspects of embodiments of the invention. In particular, the resident computer program code executing on BLDC Controller 300 may include operations to collect and store in memory 304, BLDC Motor 330 operational parameters through I/O interface 306. The operational parameters may be collected from a current sensor 324 and one or more Hall-effect sensors 336, though in other embodiments, other types of sensors may also be used. The current sensor 324 and Hall-effect sensors 336 may be electrically isolated from the I/O interface 306 by optical isolators 348, 350, 352, 354, or by some other isolation device or circuit. The current sensor 324 may provide the BLDC Controller 300 with information related to the current being supplied to the BLDC Motor 330 by the BLDC Motor Driver 310, while rotor 334 position information may be supplied by the one or more Hall-effect sensors 336.

The BLDC motor driver 310 provides voltages to the stator 332 windings based on signals from the I/O interface 306, which may be electrically isolated from the BLDC motor driver 310 by optical isolators 342, 344, 346. The voltages provided by the BLDC motor driver 310 have suitable magnitude and current sourcing ability so as to cause the rotor 334 to produce torque and rotation sufficient to provide motion to the examination table actuation systems, such as scissor lift 18 or lift cylinder 42. The BLDC motor driver 310 may include three FET gate drivers 312, 314, 316 which provide switching voltages to power transistor devices 318, 320, 322. The motor driver 310 may also include the current sensor 324 for reporting current levels back to the controller 300. The FET gate drivers 312, 314, 316 and power transistor devices 318, 320, 322 may utilize switching devices such as MOSFETs, IGFETS, bipolar transistors, SCR's, relays or any other suitable switching device.

BLDC Motor 330 includes the stator 332, the rotor 334, and one or more Hall-effect sensors 336. In one embodiment of the BLDC Motor 330, the rotor 334 is positioned inside the stator 332. However, other embodiments of BLDC motors 330 may have varied configurations placing the stator 332 in proximity to the rotor 334, such as, for example, the stator 332 may reside inside the rotor 334, or may be adjacent to the rotor 334. The stator 332 may include a number of magnetic elements arranged in a cylindrical shape. The magnetic elements include windings configured such that a magnetic field is provided in the hollow interior of the stator 332 when a current is passed through a winding. The windings are typically distributed around the periphery of the stator, forming an even number of magnetic poles. The rotor 334 is positioned within the stator 332 and includes one or more permanent magnets forming at least one magnetic pole pair, with poles alternating between north and south along the exterior periphery of the rotor 334. The rotor 334 is configured to move relative to the stator 332 by activating the stator 332 windings sequentially in a controlled manner with signals from the BLDC controller 300 as conditioned by the BLDC Motor driver 310. Hall-effect sensors 336 may be used to detect the position of the rotor 334 and provide this information to the BLDC controller 300 through I/O interface 306. The BMCA algorithm 308 in turn uses this rotor 334 position information to help generate control signals, which are sent from the BLDC motor controller 300, to the BLDC motor driver 310, forming a feedback loop.

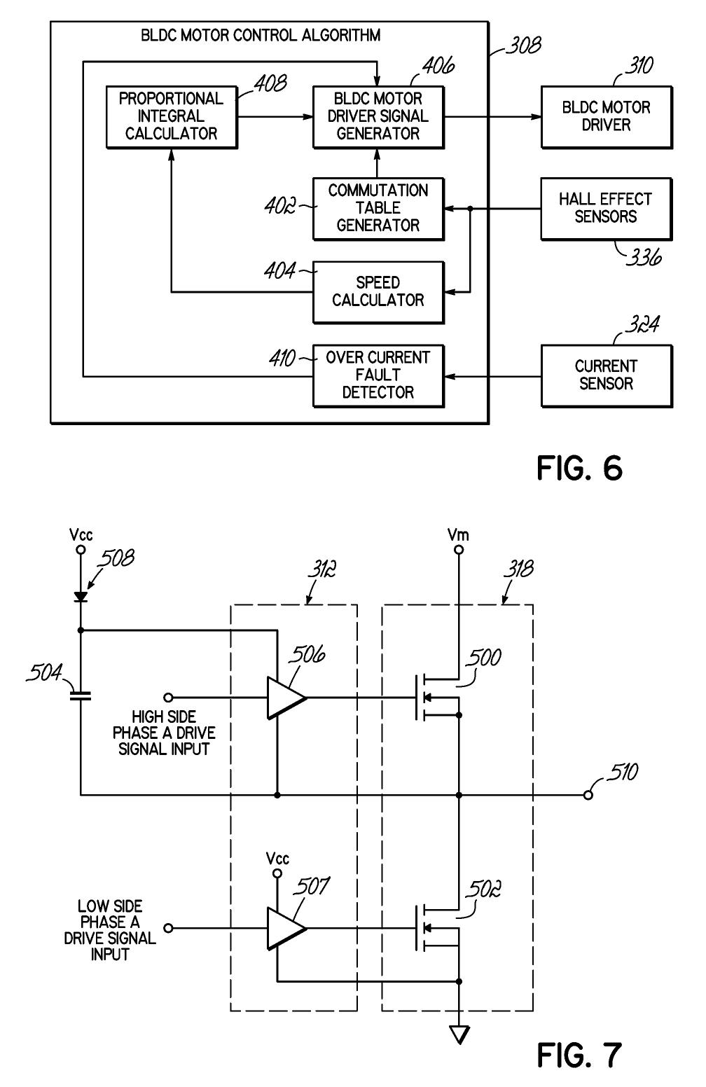

FIG. 6 is a schematic diagram of the BMCA algorithm 308 motor control run-state algorithm. As seen in FIG. 6, the signals from Hall-effect sensors 336 are loaded into the commutation table generator 402 and speed calculator 404, and signals from the current sensor 324 are loaded into the over-current fault detector 410.

When the BLDC motor 330 is running, it is normally desirable to keep the angle between stator 332 and rotor 334 magnetic fluxes at approximately 90°. In a BLDC motor employing a 3-phase stator, the angle between the rotor flux and the stator flux generally varies between approximately 60° and 120°. As the rotor 334 advances, the angle between the rotor 334 and stator 332 fluxes decreases. When the angle reaches approximately 60°, the BMCA algorithm 308 will alter the voltages supplied to the stator 332 windings, causing the stator 332 flux to advance approximately 60° to the next state so that it is now approximately 120° ahead of the rotor 334 flux. To achieve this effect, the angular position of the rotor 334 relative to the stator 332 may be calculated by a commutation table generator 402 based on the Hall-effect sensor 336 signals. Using the rotor 334 angular position, the commutation table generator 402 may calculate which stator 332 windings to energize in order to achieve the desired angle between the stator 332 and rotor 334 fluxes. The desired stator 332 windings state is then supplied by the commutation table generator 402 to the BLDM motor driver signal generator 406.

Speed of the BLDC motor 330 is controlled by the magnitude of the voltages applied to the stator 332. The magnitude of the voltage applied to the stator 332 affects the amount of current flowing through the windings, and thus the intensity of the stator 332 flux, where a stronger stator 332 flux results in more force on the rotor 334. When the force applied by the stator 332 flux causes rotor 334 torque to exceed a load on the BLDC motor 330, the rotor 334 accelerates to a higher speed. The speed calculator 404 determines the speed of the rotor 334 based on its angular position over time as supplied from the Hall-effect sensors 336. This speed information is relayed to the proportional integral calculator 408, which is configured to determine the level of voltage to apply to the stator 332 and relays this information to the BLDM motor driver signal generator 406. In BLDC motors, the voltage level is typically adjusted using pulse-width modulation (PWM) of the voltage pulses sent to the stator 332.

The current sensor 324 is configured to detect an amount current flowing through stator 332 and generates a signal proportional to that stator 332 current. The over current fault detector 410 monitors the signal from the current sensor 324, and if the stator 332 current exceeds a threshold, generates a current fault and relays the fault to the BLDM motor driver signal generator 406.

The BLDM motor driver signal generator 406 then uses the desired winding state information from the commutation table generator 402, the voltage level information from the proportional integral calculator 408, and the stator 332 current information from the over current fault detector 410 to generate a PWM signal that energizes the desired stator 332 windings with the appropriate voltage.

FIG. 7 is a schematic diagram of exemplary FET gate drivers (such as gate driver 312) and transistors (such as transistor 318), which may be used with phase A or any of the phases of the motor 330. To allow the BLDC motor 330 to produce sufficient power, it may be powered from one or more voltage sources, represented here as V_{M}, having a much higher voltage than the power supply for the BLDC controller 300, represented here by V_{CC}. When the high-side transistor 500 is switched on, the stator drive voltage 510 will rise to approximately V_{M}. This may have the tendency to cause the high-side transistor 500 to switch off unless a method of keeping the output voltage of the high-side gate driver 506 above V_{M} is implemented. One method to address this problem is to connect a boot-strap capacitor 504 between the stator drive voltage 510 and the power supply line for the high-side gate driver 506. A diode 508 allows current to flow from V_{CC} into the capacitor 504 when the stator drive voltage 510 is below V_{CC}, and assists in preventing this charge from escaping when the stator drive voltage 510 rises. This causes the voltage supply for the high-side gate driver 506 to track above the stator drive voltage 510 so that it may keep the high-side transistor 500 switched on when the stator drive voltage 510 rises above V_{CC}.

When the BLDC motor 330 has been idle for a period of time, the charge on the boot-strap capacitor 504 may bleed off. When this happens, the boot-strap capacitor may not have sufficient charge to keep the high-side gate driver 506 power supply voltage above VM when the high-side transistor 500 is switched on. The high-side gate driver 506 may then fail to activate; entering a low-voltage lock-out state instead. If this occurs, the BLDC motor 330 may not start, which is not desirable. To assist in preventing a lock-out state from occurring, when the BMCA 308 receives a command to start the BLDC motor 330 after a period of idleness, a pre-charge algorithm may be executed, which first checks the orientation of rotor 334 to determine which stator 332 winding is to be energized. The BMCA 308 then applies a voltage to a low-side gate driver 507, activating a low-side transistor 502 for that stator drive output 510, pulling the stator drive voltage 510 to ground and insuring that the boot-strap capacitor 504 is fully charged before beginning normal operation by switching to the run-state algorithm 308. The period of activation should be long enough so that the boot-strap capacitor 504 obtains sufficient charge. In one particular embodiment of the invention, the period of activation may be approximately 80 milliseconds, depending on the size of the boot-strap capacitor 504. In cases where the BLDC motor 330 is run off both positive and negative voltage supplies, the low-side transistor 502 may be activated in a similar manner to charge boot-strap capacitor 504 by connecting the stator drive voltage 510 to the negative supply.

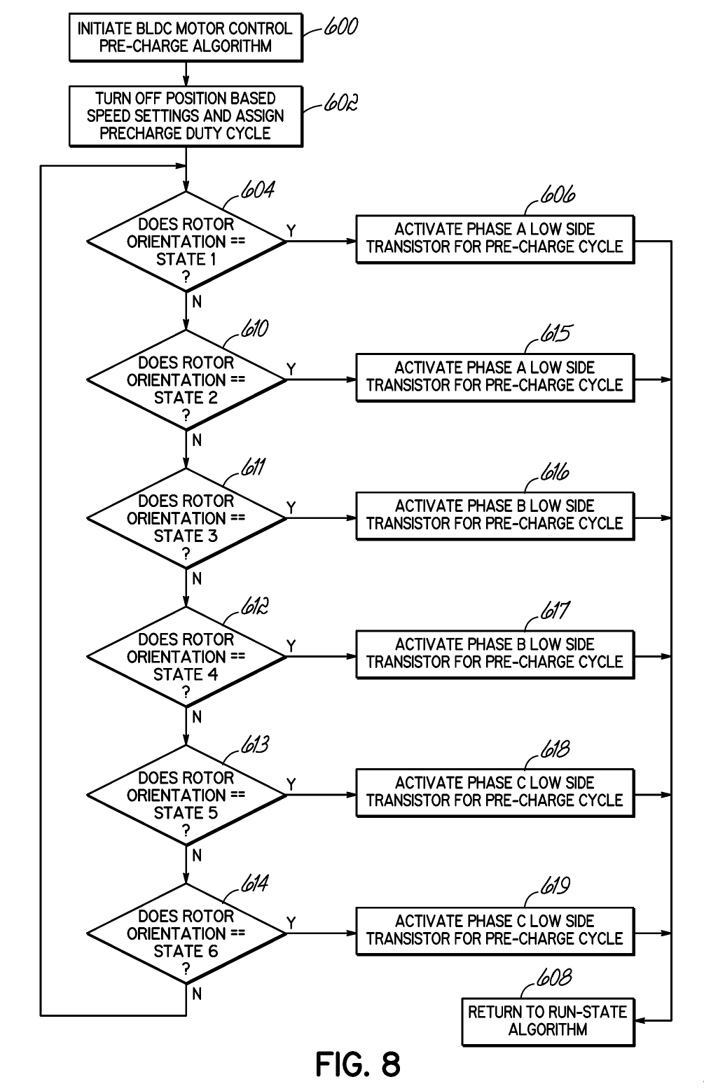

FIG. 8 is a flowchart of the previously described pre-charge algorithm. When starting the BLDC motor 330 from a stopped condition, the BMCA 308 will initiate the pre-charge algorithm in block 600. The BMCA 308 first turns off all position based speed settings so that the BLDM motor driver signal generator 406 will output an assigned pre-charge PWM duty cycle (block 602), rather than one based on the desired speed of the rotor 334. In one particular embodiment of the invention, the pre-charge PWM duty cycle may be about 9%. The BMCA 308 will check to see if the rotor 334 orientation is in state one (block 604). If so (“Yes” branch of block 604), the BMCA 308 will activate the phase A low-side transistor using the pre-charge duty cycle and duration (block 606). Once the boot-strap capacitor 504 is charged, the BMCA 308 will proceed to start the BLDC motor (block 608).

If the rotor 334 orientation is not at state one (“No” branch of block 604), the BMCA algorithm 308 will check to see if the rotor 334 orientation is in state two (block 610). If so (“Yes” branch of block 610), the BMCA 308 will activate the phase A low-side transistor using the pre-charge duty cycle and duration (block 615). Once the boot-strap capacitor 504 is charged, the BMCA 308 will proceed to start the BLDC motor (block 608).

If the rotor 334 orientation is not at state two (“No” branch of block 610), the BMCA algorithm 308 will check to see if the rotor 334 orientation is in state three (block 611). If so (“Yes” branch of block 611), the BMCA 308 will activate the phase B low-side transistor using the pre-charge duty cycle and duration (block 616). Once the boot-strap capacitor 504 is charged, the BMCA 308 will proceed to start the BLDC motor (block 608).

If the rotor 334 orientation is not at state three (“No” branch of block 611), the BMCA algorithm 308 will check to see if the rotor 334 orientation is in state four (block 612). If so (“Yes” branch of block 612), the BMCA 308 will activate the phase B low-side transistor using the pre-charge duty cycle and duration (block 617). Once the boot-strap capacitor 504 is charged, the BMCA 308 will proceed to start the BLDC motor (block 608).

If the rotor 334 orientation is not at state four (“No” branch of block 612), the BMCA algorithm 308 will check to see if the rotor 334 orientation is in state five (block 613). If so (“Yes” branch of block 613), the BMCA 308 will activate the phase C low-side transistor using the pre-charge duty cycle and duration (block 618). Once the boot-strap capacitor 504 is charged, the BMCA 308 will proceed to start the BLDC motor (block 608).

If the rotor 334 orientation is not at state five (“No” branch of block 613), the BMCA algorithm 308 will check to see if the rotor 334 orientation is in state six (block 614). If so (“Yes” branch of block 614), the BMCA 308 will activate the phase C low-side transistor using the pre-charge duty cycle and duration (block 619). Once the boot-strap capacitor 504 is charged, the BMCA 308 will proceed to start the BLDC motor (block 608).

If the rotor 330 orientation is not at state six (“No” branch of block 614), then checking begins again at block 604, or in other embodiments, an error signal may be produced, or the algorithm may proceed to start the BLDC motor (block 608).

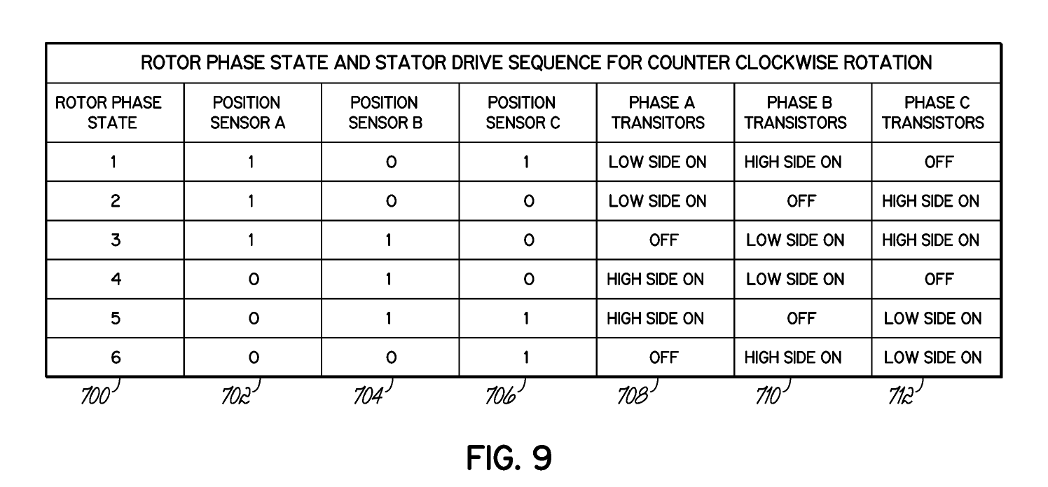

FIG. 9 is a table containing Hall-effect sensor 336 output states 702, 704, 706, and associated BLDC Motor Driver transistor 318, 320, 322 drive states 708, 710, 712, with respect to their associated rotor 334 phase states 700 for an exemplary embodiment of the invention. Although different numbers of Hall-effect sensors may be employed, in this particular embodiment, the rotor 334 has three Hall-effect sensors 336, which results in six rotor phase state 700 measurements. Each rotor phase state 700 in this embodiment represents a rotor 334 orientation within a range of approximately 60°, such that the six phase states 700 encompass a full 360° rotation. The BLDC Controller 300 may thus use the Hall-effect sensor 336 signals to determine an approximate position of rotor 334 relative to stator 332. The BLDC motor driver 310 input signals originating from the BLDC controller 300 cause the BLDC motor driver transistors 318, 320, 322 to be activated as discussed above. To maintain counter-clockwise rotation of the rotor 334, the states are activated using the sequence 1-2-3-4-5-6-1-2-3-4-5-6 and so on. As the rotor 334 advances, the Hall-effect sensors 336 indicate when the rotor 334 has entered a new phase state 700. The BLDC controller 300 may then alter the BLDC motor driver transistor 318, 320, 322 drive state 708, 710, 712 in such a way that the phase of the stator 332 flux advances, thus keeping the stator 332 flux ahead of the rotor 334 by switching on and off the appropriate driver transistors 318, 320, 322.

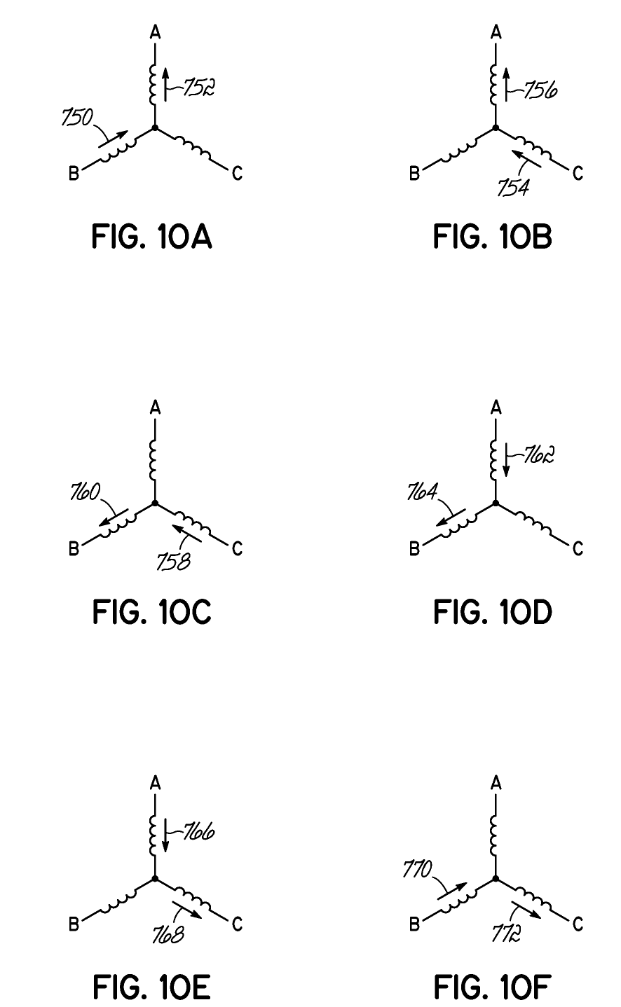

Referring now to FIGS. 10A-F, for illustrative purposes, diagrammatic representations are presented showing the stator 332 winding currents associated with the driver transistor 318, 320, 322 states in FIG. 9 for a stator 332 having three windings. FIG. 10A shows the stator 332 winding current 750 flowing into stator 332 through winding B and stator 332 winding current 752 flowing out of stator 332 through winding A when rotor phase state 700 one in FIG. 9 is active.

FIG. 10B shows stator 332 winding current 754 flowing into stator 332 through winding C and current 756 flowing out of stator 332 through winding A when rotor phase state 700 two in FIG. 9 is active.

FIG. 10C shows stator 332 winding current 758 flowing into stator 332 through winding C and current 760 flowing out of stator 332 through winding B when rotor phase state 700 three in FIG. 9 is active.

FIG. 10D shows stator 332 winding current 762 flowing into stator 332 through winding A and current 764 flowing out of stator 332 through winding B when rotor phase state 700 four in FIG. 9 is active.

FIG. 10E shows stator 332 winding current 766 flowing into stator 332 through winding A and current 768 flowing out of stator 332 through winding C when rotor phase state 700 five in FIG. 9 is active.

FIG. 10F shows stator 332 winding current 770 flowing into stator 332 through winding B and current 772 flowing out of stator 332 through winding C when rotor phase state 700 six in FIG. 9 is active.

A BLDC motor 330 employing a stator 332 with three windings thus has six phase states, with each state representing the stator 332 magnetic flux orientation generated by windings energized as shown. The BMCA 300 run-state algorithm may also incorporate adjustments to BLDC motor driver signal phase in order to compensate for the effects of rotor 334 motion and to maintain desired flux orientation between the stator 332 and rotor 334 while the BLDC motor 330 is in operation.

The relationship between rotor 334 phase and stator 332 drive currents desired for motor operation while the rotor 334 is in motion may be non-optimal for inducing motion in the rotor 334 when it is stationary. For example, if run-state algorithm phase relationships are used under start-up conditions, the motor 330 may not move initially, or more seriously, move backwards. Because initial retrograde motion of an exam table may be startling during a medical examination, it is highly desirable for the BLDC motor 330 to start moving in the correct direction at start-up. To ensure that initial start-up direction is correct, the phase-retardation algorithm detects that the motor is in start-up mode, and adjusts the BLDC motor driver 310 phase by retarding it one state. In one embodiment of the invention, this may be accomplished by adjusting the Hall-effect sensor 336 signals so that the BLDC Controller 300 generates BLDC Motor Driver 310 driver signals for a rotor phase state 700 one state behind what would be generated while in the run-state. For example, if rotor 334 is in rotor phase state 700 two at start-up, the Hall Effect position sensor 336 signals are adjusted to be 1-0-1 instead of 1-0-0 for purposes of determining desired stator 332 winding currents. The phase-retardation algorithm maintains phase retardation for one or more rotor phase state 700 transactions as required until the BLDC motor 330 is safely rotating in the desired direction. Although for clarity, the exemplary embodiment of the invention represented by FIGS. 9 and 10A-F operates with a counterclockwise rotation, it will be apparent to a person having ordinary skill in the art that the sequence of stator drive currents may be easily altered to achieve clockwise rotation. It will also be apparent that the duration and magnitude of phase-retardation that provides optimal start-up characteristics may vary depending on the specific configuration of the BLDC motor 330, and its relation to the medical examination table 10.

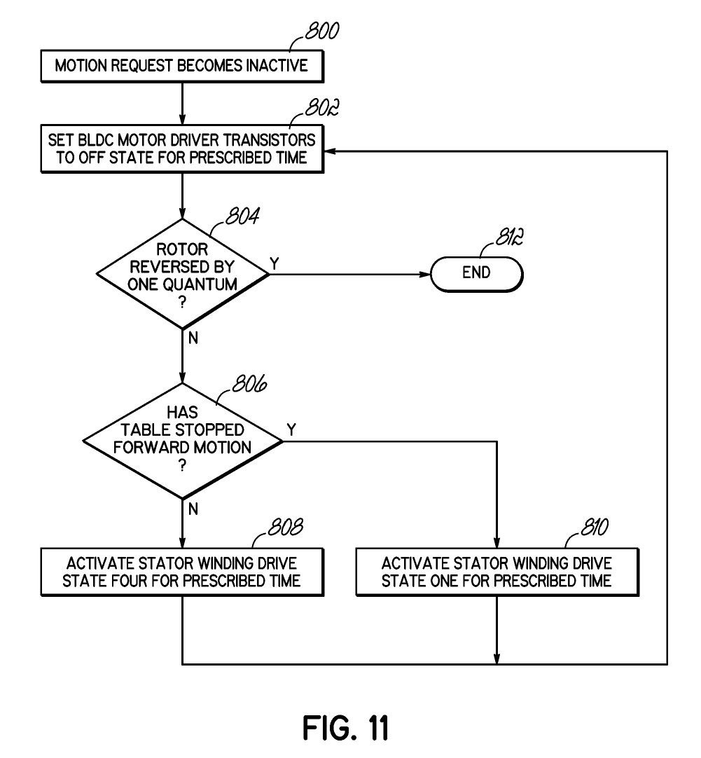

Referring now to FIG. 11, a flow chart is presented representing a braking algorithm in accordance with an embodiment of the invention. When the examination table 10 has reached its desired position, typically a controller 52 button is released, and the motion request becomes inactive 800. When this occurs, it is advantageous to prevent the examination table 10 from overshooting or drifting past the desired stopping point. To assist in stopping the examination table 10, it may be desirable to cause the BLDC motor 330 to apply torque in opposition to the forward motion of the examination table 10. However, if the BLDC motor 330 is simply reversed under full power, the examination table 10 may move backwards away from the desired stopping point. Determining an amount of reverse torque to apply and for how long may also be complicated by the load on the examination table 10 varying greatly depending on whether or not a patient is occupying the table, and from variations in patient size and weight. By toggling between two of the possible six BLDC motor drive states, the BLDC motor 330 may be used to actively brake the exanimation table 10 without producing unwanted reverse motion. When the motion request becomes inactive 800, the BMCA 308 will execute a braking algorithm that causes the BLDC Motor Driver transistors 318, 320, 322 to go into off states for a predetermined period of time, for example, about one millisecond 802. After the prescribed time has elapsed, the BMCA will use the Hall-effect sensors 336 to determine if the rotor 334 has moved in a retrograde direction for a distance equal to the minimum rotor 334 position resolution—or quantum—detectable 804. In one embodiment of the invention, the minimum rotational position resolution, or quantum, is about 20°. If the rotor 334 has reversed by one quantum, the BLDC motor driver transistors 318, 320, 322 will be left in the off state and the brake algorithm ends (block 812) and will return control to the run-time algorithm. If the rotor 334 has not reversed, the BMCA 308 determines if forward motion has stopped 806. If the BMCA 308 determines forward motion has not stopped, the BMCA 308 will activate the BLDC motor driver transistors 318, 320, 322 for rotor phase state 700 four as shown in FIGS. 9 and 10D for about one millisecond 808 before returning to the off state 802. Otherwise, the BMCA 308 will activate the BLDC motor driver transistors 318, 320, 322 for rotor phase state 700 one as shown in FIGS. 9 and 10A for about one millisecond 810 before returning to the off state 802. In other embodiments, other prescribed amounts of time other than about one millisecond may also be used. Steps 802, 804, 806, 808 and 810 are then repeated until the BMCA 300 determines that the rotor 334 has reversed by one quantum, at which point the BMCA 300 exits the braking algorithm 812 and returns control to the run-state algorithm. Although the preceding embodiment discloses toggling between the motor drive states represented by rotor phase states 700 one and four as presented in FIGS. 9 and 10A-F; in alternative embodiments of the invention, the braking algorithm may toggle between other motor drive states represented in FIGS. 9 and 10A-F, or between a larger number of motor drive states up to and including one less than the total number of winding drive states available. Once the motor is stopped, the table may be maintained in a fixed position by friction and/or components in a transmission connecting the motor to the table. Alternative embodiments of the invention may include additional brakes, friction devices, and/or locking mechanisms to assist in maintaining table position.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A motor control system for an examination table, comprising:
a motor drive circuit including:
a high-side transistor coupled to a high-side gate driver;
a low-side transistor coupled to a low-side gate driver;
a boot-strap capacitor coupled with the high-side gate driver; and
a motor controller configured to:
determine a position of a rotor of a motor;
in response to the determined position of the rotor, activate the low-side gate driver to switch on the low-side transistor, wherein switching on the low-side transistor causes the boot-strap capacitor to charge;
deactivate the low-side gate driver to switch off the low-side transistor; and
activate the high-side gate driver to switch on the high-side transistor, wherein switching on the high-side transistor causes a voltage to be supplied to a stator of the motor.

2. The motor control system of claim 1, further comprising a position sensor.

3. The motor control system of claim 2, wherein the position sensor is a hall-effect sensor.

4. The motor control system of claim 1, wherein activating the low-side gate driver comprises:
periodically applying a voltage to the low-side gate driver,
wherein the periodically applied voltage corresponds to a predetermined pulse-width modulation duty cycle.

5. The motor control system of claim 4, wherein the predetermined pulse-width modulation duty cycle is approximately 9 percent.

6. The motor control system of claim 1, wherein the low-side gate driver is activated for a predetermined time period.

7. The motor control system of claim 6, wherein the predetermined time period is approximately 80 milliseconds.

8. A method of starting a brushless direct current motor, comprising:
determining a position of a rotor of a motor;
in response to the determined position of the rotor, activating a low-side gate driver of a motor drive circuit to switch on a low-side transistor of the motor drive circuit, wherein switching on the low-side transistor causes a boot-strap capacitor of the motor drive circuit to charge;
deactivating the low-side gate driver to switch off the low-side transistor;
activating a high-side gate driver of the motor driver circuit to switch on a high-side transistor of the motor drive circuit, wherein switching on the high-side transistor causes a voltage to be supplied to a stator of the motor.

9. The method of claim 8, wherein activating the low-side gate driver comprises:
periodically applying a voltage to the low-side gate driver,
wherein the periodically applied voltage corresponds to a predetermined pulse-width modulation duty cycle.

10. The method of claim 9, wherein the predetermined pulse-width modulation duty cycle is approximately 9 percent.

11. The method of claim 8, wherein the low-side gate driver is activated for a predetermined time period.

12. The method of claim 9, wherein the predetermined time period is approximately 80 milliseconds.

13. An examination table comprising:
a base;
a support surface mounted on the base and including a seat portion and a backrest portion;
a brushless direct current motor configured to drive at least a portion of support surface with respect to the base;
a control panel configured to generate control signals for controlling the brushless direct current motor;
a motor drive circuit including:
a high-side transistor coupled to a high-side gate driver;
a low-side transistor coupled to a low-side gate driver;
a boot-strap capacitor coupled with the high-side gate driver;
a motor controller responsive to the control signals generated by the control panel and configured drive the brushless direct current motor via the motor drive circuit by:
determining a position of a rotor of the brushless direct current motor;
in response to the determined position of the rotor, activating the low-side gate driver to switch on the low-side transistor, wherein switching on the low-side transistor causes the boot-strap capacitor to charge;
deactivating the low-side gate driver to switch off the low-side transistor;
activating the high-side gate driver to switch on the high-side transistor, wherein switching on the high-side transistor causes a voltage to be supplied to a stator of the brushless direct current motor.

14. The examination table of claim 13, further comprising a position sensor.

15. The examination table of claim 14, wherein the position sensor is a hall-effect sensor.

16. The examination table of claim 13, wherein activating the low-side gate driver comprises:
periodically applying a voltage to the low-side gate driver;
wherein the periodically applied voltage corresponds to a predetermined pulse-width modulation duty cycle.

17. The examination table of claim 14, wherein the predetermined pulse-width modulation duty cycle is approximately 9 percent.

18. The examination table of claim 13, wherein the low-side gate driver is activated for a predetermined time period.

19. The examination table of claim 18, wherein the predetermined time period is approximately 80 milliseconds.
